(19) United States
(12) Patent Application Publication
(10) Pub. No.: US 2025/0378203 A1
(43) Pub. Date: Dec. 11, 2025

(54) HISTORY SYNCHRONIZATION SERVICE AND PROTECTION EXTENSION

(71) Applicant: CITRIX SYSTEMS, INC., Fort Lauderdale, FL (US)

(72) Inventors: ZONGPENG QIAO, NANJING (CN); DAN HU, NANJING (CN); KE XU, NANJING (CN); JIE ZHUANG, NANJING (CN)

(21) Appl. No.: 18/874,370

(22) PCT Filed: Sep. 28, 2022
(86) PCT No.: PCT/CN2022/122282

§ 371 Date: Dec. 12, 2024

(51) Int. Cl. G06F 21/62; G06F 8/61; G06F 9/445

(52) U.S. Cl. CPC G06F 21/6263; G06F 8/61; G06F 9/44526

(57) ABSTRACT

Methods and systems for selective presentation of sensitive information are described herein. A computing system may receive, from a cloud computing platform, a history protection extension. The computing system may install the history protection extension, which may cause the computing system to selectively display sensitive information based on whether or not the computing system is connected to a secure network. The computing system may identify, using the history protection extension, that the computing system is currently operating on the secure network. The computing system may intercept a URL access request. The computing system may compare a domain of the URL access request to a protection domain list. Based on identifying that the domain of the URL is included on the protection domain list, the computing system may launch the URL in a secure browser, and display, within the secure browser and based on a history data list, the sensitive information.

### FIELD

Aspects described herein generally relate to computer networking, remote computer access, virtualization, enterprise mobility management, and hardware and software related thereto. More specifically, one or more aspects described herein include a cloud based history synchronization service and protection extension for selective exposure of sensitive information.

### BACKGROUND

In some instances, browsers may synchronize a user's browsing history across various different devices (e.g., laptop computers, desktop computers, mobile devices, or the like). Although this may be convenient in personal computing, in enterprise scenarios, such as where virtual desktops are used, such synchronization between browsers may risk exposing sensitive information. For example, without any secure access authentication, when a browser is launched on a mobile device, a browsing history, bookmark information, and/or autocomplete/association (e.g., based on a few input characters at the beginning of a URL string) features, which may, e.g., be associated with secure enterprise browsing sessions, may be displayed in a user's non-secure sessions on a synchronized browser on a different computer (e.g., at home or other non-enterprise location). Accordingly, it may be important to enable browser synchronization without the risk of exposing sensitive information.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards selective display of sensitive information based on network status. One or more embodiments are related to receiving, from a cloud computing platform, a history protection extension for a web browser; automatically installing, at a user device and based on receipt of the history protection extension, the history protection extension, wherein installing the history protection extension causes the user device to selectively display sensitive information based on whether or not the user device is connected to a secure network; identifying, using the history protection extension, that the user device is currently operating on the secure network; intercepting, by the history protection extension, a uniform resource locator (URL) access request; comparing a domain of the URL access request to a protection domain list; and based on identifying that the domain of the URL is included on the protection domain list: launching the URL in a secure browser, which may cause browsing data to be recorded to the history sync service rather than a local browser; and displaying, within the secure browser and based on a history data list from a history synchronization service hosted by the cloud computing platform, the sensitive information.

One or more examples are directed to registering, by the user device and with the history synchronization service hosted at the cloud computing platform, the user device. In one or more instances, the installation of the history protection extension may be automatically triggered based on the registration by the user device with the history synchronization service.

One or more embodiments are directed to based on identifying that the user device is currently operating on the secure network, recording the URL to the history data list of the history synchronization service. One or more embodiments are directed to based on identifying that the user device is currently operating on the secure network, recording user interaction information, corresponding to the sensitive information, to the history data list of the history synchronization service.

One or more examples are directed to identifying that the user device is no longer operating on the secure network; and based on identifying that the user device is no longer operating on the secure network, identifying that the sensitive information should not be displayed. In one or more examples, identifying that the user device is operating on the secure network may include: requesting access to an internal URL; and based on identifying that access is granted to the internal URL, identifying that the user device is operating on the secure network.

In one or more embodiments, the sensitive information may include one or more of: URL autocomplete information, recommendation information, URL favorites information, or information of the URL. In one or more embodiments, the sensitive information may include bookmark information. One or more examples are directed to, based on identifying that the domain of the URL is not included on the protection domain list, launching the URL in a standard browser.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5C depict an illustrative computing environment for secure storage and selective exposure of sensitive information in accordance with one or more illustrative aspects described herein.

FIGS. 6A and 6B depict an illustrative event sequence for secure storage and selective exposure of sensitive information in accordance with one or more illustrative aspects described herein.

FIG. 7 depicts an illustrative method for secure storage and selective exposure of sensitive information in accordance with one or more illustrative aspects described herein.

FIGS. 8A and 8B depict an illustrative event sequence for secure storage and selective exposure of sensitive information one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards a history synchronization service and history protection extension for selective exposure of sensitive information. A mechanism is described for storing intranet access records in a secured database instead of being synced by a browser to other devices. A secured browsing history may be filtered by domains that may be configured by an administrator. Bookmark information may similarly be stored in the secured database. Information based on such intranet access records/bookmarks may then be selectively displayed to a user based on whether or not the user is currently operating on a secure network.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted.” “connected,” “coupled,” “positioned,” “engaged” and similar terms, is meant to include both direct and indirect mounting, connecting, coupling, positioning and engaging.

### Computing Architecture

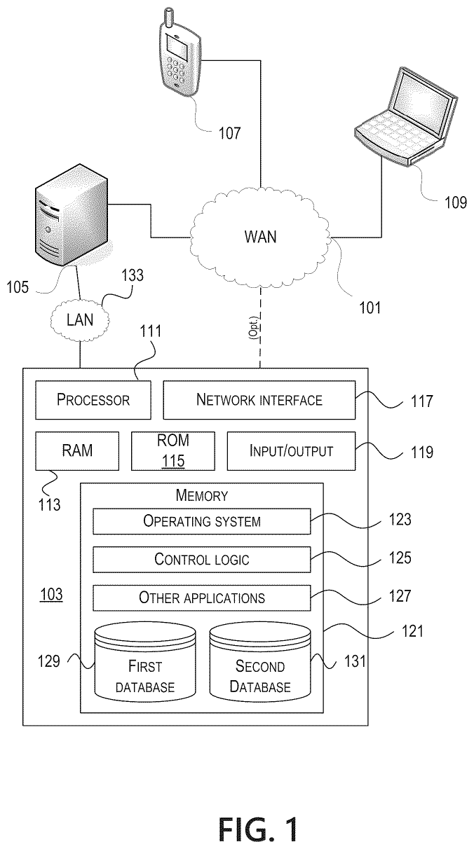

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (V/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

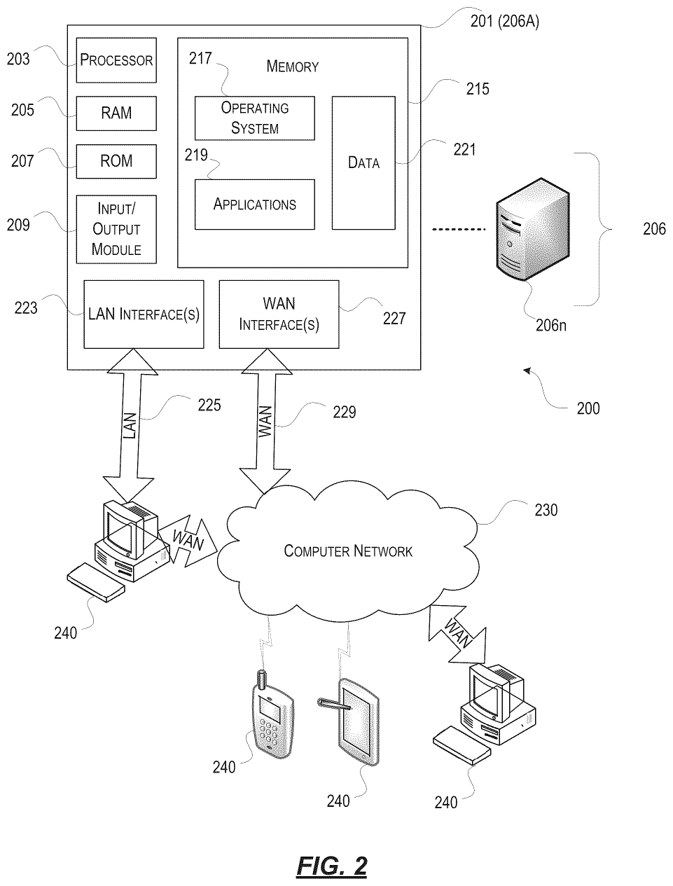

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, IOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

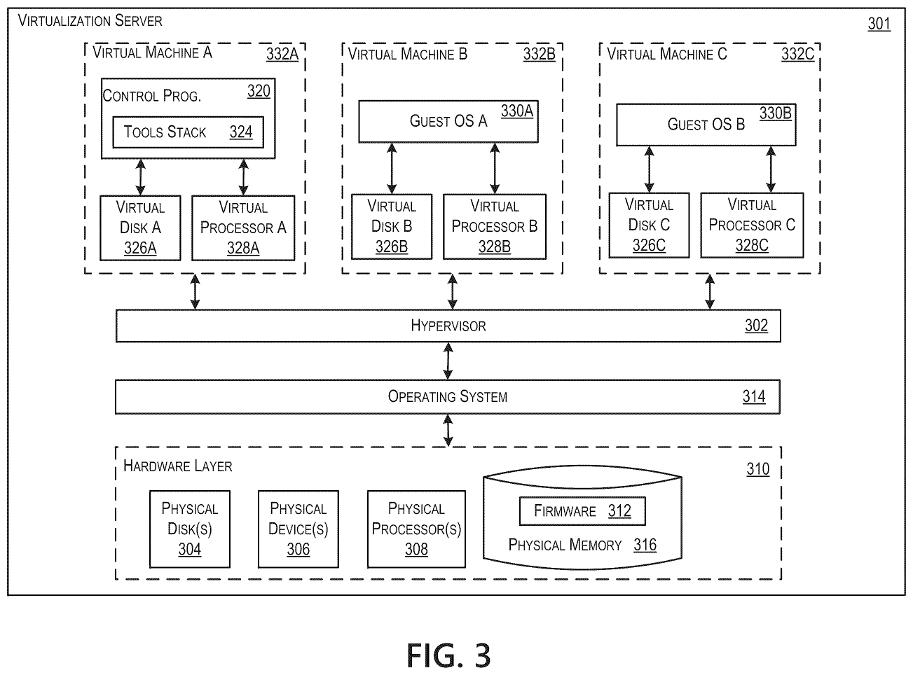

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

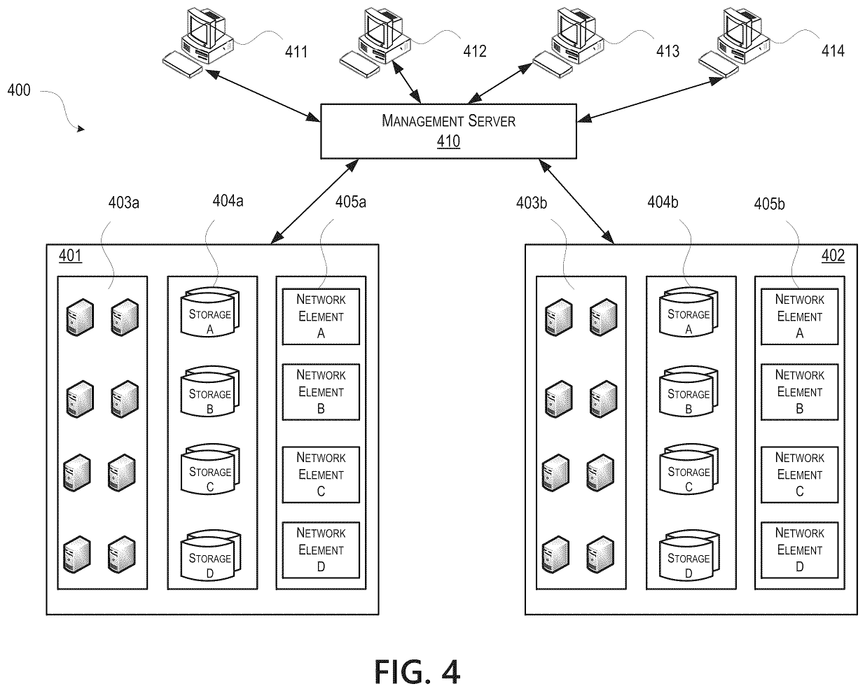

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### History Synchronization Service and Protection Extension for Selective Exposure of Sensitive Information

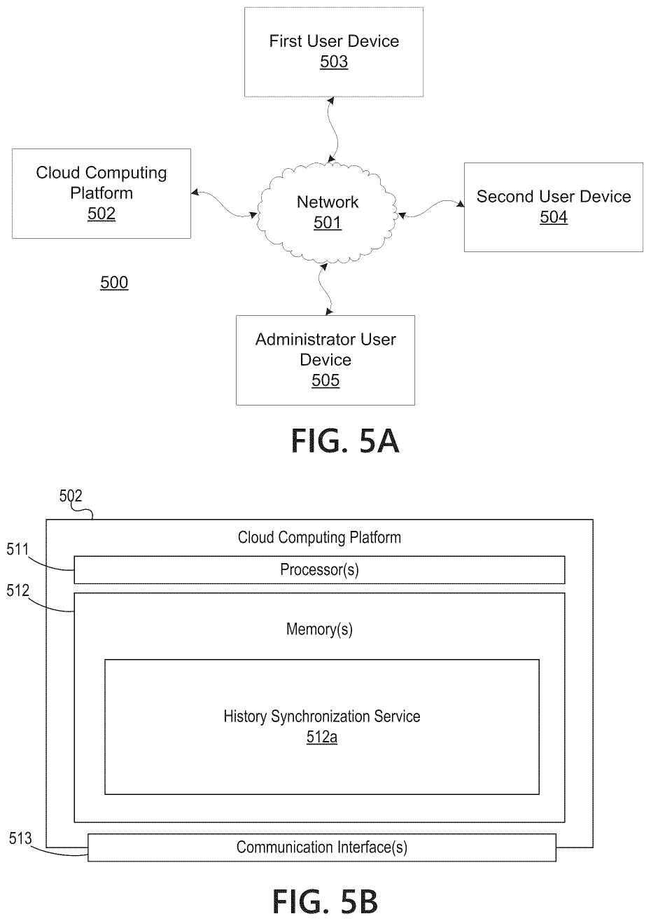

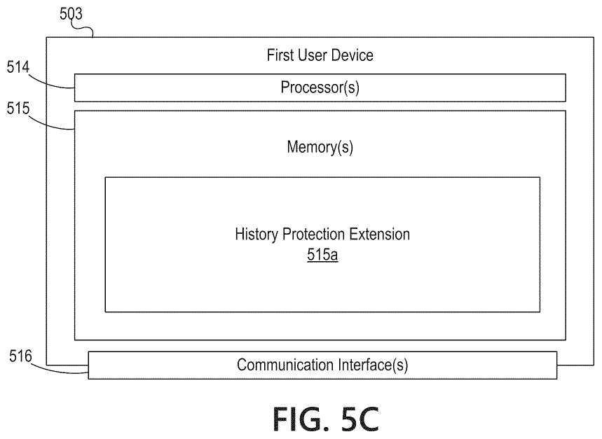

FIGS. 5A-5C depict an illustrative computing environment for secure storage and selective exposure of sensitive information in accordance with one or more example embodiments. Referring to FIG. 3A, computing environment 300 may include one or more computer systems. For example, computing environment 300 may include cloud computing platform 502, first user device 503, second user device 504, and administrator user device 505.

As illustrated further below, cloud computing platform 502 (which may be similar to web server 105 or data server 103, shown in FIG. 1, and/or computing device 201 or server 206, shown in FIG. 2), may be configured to host a history synchronization service for secure storage of sensitive information. For example, the history synchronization service may be configured to store historical information associated with internal or otherwise sensitive websites, browsing history information, bookmark information, and/or other information. In some instances, the cloud computing platform 502 may be configured to push a history protection extension to one or more user devices, which may cause the one or more user devices to selectively display sensitive information based on a current network of the one or more user devices, as is described further below.

First user device 503 (which may, e.g., be a computing device similar to devices 107 or 109, shown in FIG. 1, or client machine 240, shown in FIG. 2) may include one or more computing devices configured to perform one or more of the functions described herein. For example, first user device 503 may be a laptop computer, desktop computer, mobile device, a tablet, a smart phone, and/or other device configured to host, store, or otherwise support a browser application. In some instances, the first user device 503 may be configured to host a history protection extension, which may enable the first user device 503 to selectively display sensitive information, as described further below. For example, the history protection extension may cause the first user device 503 to intercept a URL access request, identify whether or not the first user device 503 is currently operating on a secure network, and selectively display the sensitive information, corresponding to the URL access request, accordingly. In some instances, the first user device 503 may be configured to display one or more graphical user interfaces (e.g., browser interfaces, or the like), which in some instances may include sensitive information.

Second user device 504 (which may, e.g., be a computing device similar to devices 107 or 109, shown in FIG. 1, or client machine 240, shown in FIG. 2) may include one or more computing devices configured to perform one or more of the functions described herein. For example, second user device 504 may be a laptop computer, desktop computer, mobile device, a tablet, a smart phone, and/or other device configured to host, store, or otherwise support a browser application. In some instances, the second user device 504 may be configured to host a history protection extension, which may enable the second user device 504 to selectively display sensitive information, as described further below. For example, the history protection extension may cause the second user device 504 to intercept a URL access request, identify whether or not the second user device 504 is currently operating on a secure network, and selectively display the sensitive information, corresponding to the URL access request, accordingly. In some instances, the second user device 504 may be configured to display one or more graphical user interfaces (e.g., browser interfaces, or the like), which in some instances may include sensitive information.

Administrator user device 505 (which may, e.g., be a computing device similar to devices 107 or 109, shown in FIG. 1, or client machine 240, shown in FIG. 2) may include one or more computing devices configured to perform one or more of the functions described herein. For example, administrator user device 505 may be a laptop computer, desktop computer, mobile device, a tablet, a smart phone, and/or other device configured to host, store, or otherwise communicate with the cloud computing platform 502. In some instances, the administrator user device 505 may be configured to provide a list of domains with which sensitive information is associated.

Computing environment 500 may also include one or more networks, which may interconnect cloud computing platform 502, first user device 503, second user device 504, administrator user device 505. For example, computing environment 500 may include a network 501 (which may e.g., cloud computing platform 502, first user device 503, second user device 504, and/or administrator user device 505). In some instances, the network 501 may be similar to computer network 230, which is shown in FIG. 2.

In one or more arrangements, cloud computing platform 502, first user device 503, second user device 504, administrator user device 505, and/or the other systems included in computing environment 500 may be any type of computing device capable of supporting selective storage and/or display of sensitive information. For example, cloud computing platform 502, first user device 503, second user device 504, administrator user device 505, and/or the other systems included in computing environment 500 may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of cloud computing platform 502, first user device 503, second user device 504, and/or administrator user device 505 may, in some instances, be special purpose computing devices configured to perform specific functions.

Referring to FIG. 5B, cloud computing platform 502 may include one or more processors 511, memory 512, and communication interface 513. A data bus may interconnect processor 511, memory 512, and communication interface 513. Communication interface 513 may be a network interface configured to support communication between the cloud computing platform 502 and one or more networks (e.g., network 501, or the like). Memory 512 may include one or more program modules having instructions that when executed by processor 511 cause cloud computing platform 502 to perform one or more functions described herein and/or access one or more databases that may store and/or otherwise maintain information which may be used by such program modules and/or processor 511. In some instances, the one or more program modules and/or databases may be stored by and/or maintained in different memory units of cloud computing platform 502. For example, cloud computing platform 502 may have, host, store, and/or include a history synchronization service 512a, which may be configured to store and selectively provide sensitive data to client devices.

Referring to FIG. 5C, first user device 503 may include one or more processors 514, memory 515, and communication interface 516. A data bus may interconnect processor 514, memory 515, and communication interface 516. Communication interface 516 may be a network interface configured to support communication between the first user device 503 and one or more networks (e.g., network 501, or the like). Memory 515 may include one or more program modules having instructions that when executed by processor 513 cause first user device 503 to perform one or more functions described herein and/or access one or more databases that may store and/or otherwise maintain information which may be used by such program modules and/or processor 514. In some instances, the one or more program modules and/or databases may be stored by and/or maintained in different memory units of first user device 503. For example, cloud computing platform 502 may have, host, store, and/or include a history protection extension 515a, which may be configured to intercept URL access requests, detect an active network, and/or selectively provide sensitive information based on the detected network.

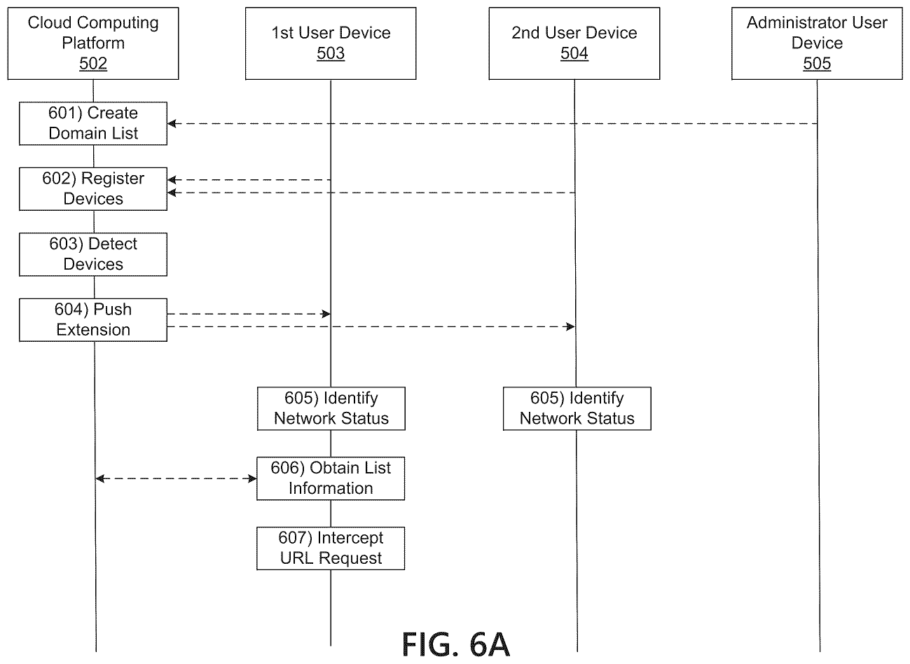

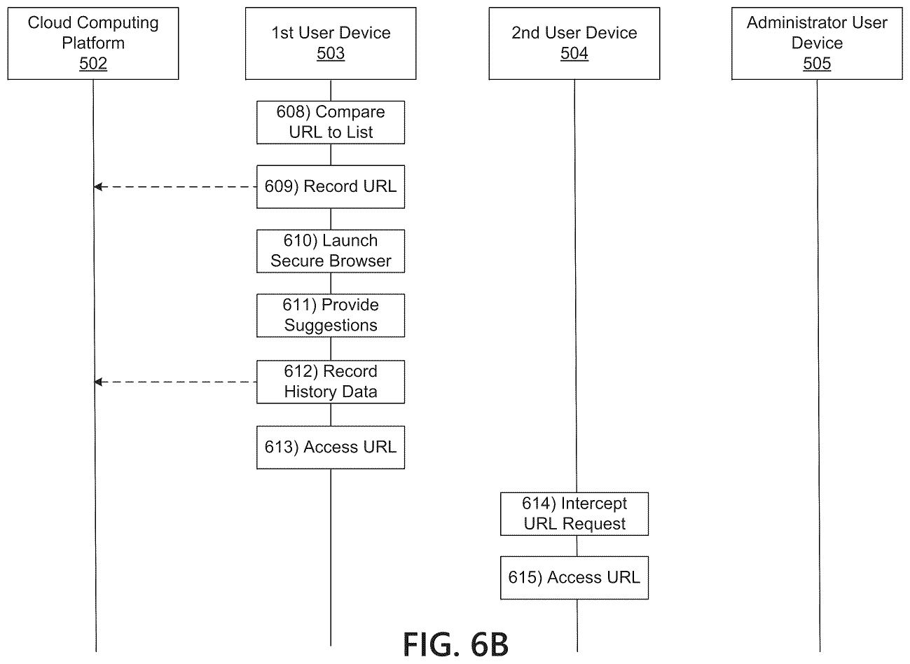

FIGS. 6A and 6B depict an illustrative event sequence for secure storage and selective exposure of sensitive information in accordance with one or more example embodiments. It should be understood that steps 601-615 may, in some instances, occur in the order as shown with regard to FIGS. 6A and 6B. For example, after completing step 607 of FIG. 6A, the event sequence may proceed to step 608 of FIG. 6B.

Referring to FIG. 6A, at step 601, the administrator computing device 305 may communicate with the cloud computing platform 502 to create a protection domain list. For example, in some instances, a user of the administrator computing device 305 may input domains that may include sensitive and/or other information, and these domains may be sent to the cloud computing platform 502. Once received, the cloud computing platform 502 may store the protection domain list in the history sync service. Additionally or alternatively, the cloud computing platform 502 may receive the domains from an automated service, which may, e.g., automatically identify the domains that include sensitive information.

At step 602, the first user device 503, second user device 504, and/or any other user devices may register with the history sync service. For example, in some instances, the first user device 503 and/or second user device 504 may be configured to access the history sync service once enrolled with an enterprise organization (e.g., corresponding to the history sync service).

At step 603, the cloud computing platform 502 may detect any user devices, registered with the history sync service, at which the history protection extension has not yet been installed. For example, the cloud computing platform 502 may detect that the history protection extension has not yet been installed at the first user device 503 and/or second user device 504 (e.g., based on a record of devices to which the cloud computing platform 502 has pushed the extension).

At step 604, the cloud computing platform 502 may push the history protection extension to the user devices detected at step 603 (e.g., first user device 503 and/or second user device 504). For example, the cloud computing platform 502 may send the history protection extension and one or more commands directing the first user device 503 and/or the second user device 504 to install the history protection extension, which may, e.g., cause the first user device 503 and/or second user device 504 to install the history protection extension. In some instances, the cloud computing platform 502 may send these commands based on receiving a registration request from a particular user device. In these instances, the cloud computing platform 502 may ensure that the history protection extension is installed at the particular user device without any actions on behalf of the user of the given user device. Additionally or alternatively, the cloud computing platform 502 may send a message indicating that the history protection extension should be installed, which may, e.g., include a link to download the history protection extension. In either scenario, the first user device 503 and/or second user device 504 may install the history protection extension.

At step 605, once the history protection extension has been installed, the first user device 503 and/or second user device 504 may identify a network on which they are operating, and, more specifically, whether that network is a secure network. For example, the first user device 503 and/or second user device 504 may identify whether or not the current network environment is an internal secure network (e.g., virtual desktop access (VDA), a secure access authenticated environment, and/or other secure network access). To do so, the first user device 503 and/or second user device 504 may use the history protection extension to store a URL for a default website that may only be accessed on the internal secure network. The history protection extension may send a ping request to the default website to see if it is accessible. If the history protection extension identifies that the default website is accessible, it may identify that the network is an internal secure network. Otherwise, if the history protection extension identifies that the default website is not accessible, it may identify that the network is not an internal secure network. For illustrative purposes, it may be assumed that the first user device 503 may identify that it is currently operating on a secure internal network, whereas the second user device 504 may identify that it is not currently operating on a secure internal network.

At step 606, based on identifying that the first user device 503 is operating on the secure internal network, the history protection extension of the first user device 503 may communicate with the history sync service of the cloud computing platform 502 to obtain the protection domain list and a history data list (e.g., including historical data of the user's interactions with the websites on the protection domain list, favorites, browsing history information, autocomplete recommendations and/or other information) for the user. In some instances, the first user device 503 may obtain a protection domain list and/or history data list that is unique to a user of the first user device 503, shared between multiple users, and/or otherwise. In some instances, the protection domain list and/or history data list may be identified based on a correlation between two similarly situated users (e.g., information from one user may be used to information the lists of the other).

At step 607, the user of the first user device 503 may input a URL into a browser operating on the first user device 503. The history protection extension of the first user device 503 may intercept the URL during input. By intercepting URLs in this way, the history protection extension of the first user device 503 may protect individuals while operating on the enterprise network without any further necessary action on behalf of the individual, as described further below.

Referring to FIG. 6B, at step 608, the history protection extension of the first user device 503 may analyze the URL to determine whether or not sensitive information will be displayed. For example, the history protection extension may compare the intercepted URL to the protection domain list. If the history protection extension identifies that the intercepted URL is not listed on the protection domain list, the first user device 503 may proceed to step 613. Otherwise, if the history protection extension identifies that the intercepted URL is listed on the protection domain list, the first user device 503 may proceed to step 609.

At step 609, the history protection extension of the first user device 503 may communicate with the history sync service of the cloud computing platform 502 to record the intercepted URL as history data. For example, the first user device 503 may cause the history sync service to record historical information for the user of the first user device 503, indicating that the intercepted URL was accessed.

At step 610, the history protection extension of the first user device 503 may cause the intercepted URL to be launched in a secure browser. For example, if the URL was input in a standard browser, the history protection extension may cause a secure browser to instead be initiated, and may launch the intercepted URL within the secure browser rather than the standard browser. In doing so, the history protection extension of the first user device 503 may cause a browsing history (or other sensitive information) not to be locally stored (which would, e.g., make the browsing history accessible regardless of whether or not the first user device 503 is operating on the secure internal network), but rather may cause the browsing history (or other sensitive information) to be routed to the history sync service accordingly.

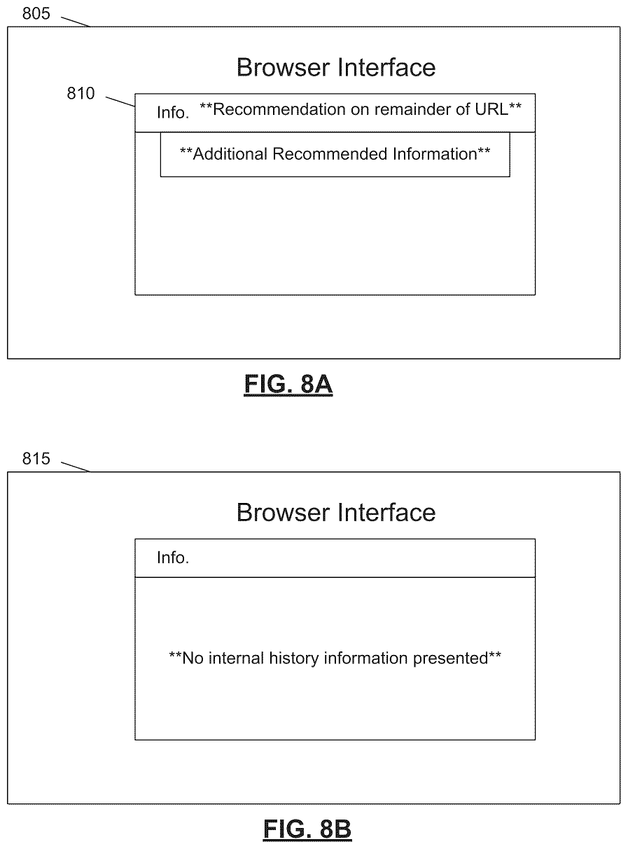

At step 611, the history protection extension of the first user device 503 may cause sensitive information (e.g., suggestions, browsing history information, historical access information, recommendations, auto-complete information, favorites information, bookmark information, and/or other information) to be displayed within the secure browser. In some instances, the secure browser may be an independent browser application. Additionally or alternatively, the secure browser may be a new tab and/or traceless browsing mode within the same browser application. For example, the history protection may provide user association suggestions if any history data matched the user's input header, and may provide user options as shown in graphical user interface 805, which is shown in FIG. 8A. For example, a user may begin entering “info.” into the address bar 810, and the history protection extension may identify, based on the history data list, that the user previously accessed a particular URL beginning with “info.” such as “info.remainderofURL.com.” Accordingly, the history protection extension of the first user device 503 may cause the remainder of the URL to be displayed to the user within the address bar 810, which may, e.g., allowed the user to access the entire URL without typing it in its entirety. Similarly, bookmarks to sensitive webpages may be displayed to the user within the secure browser.

At step 612, as the user interacts with the secure browser (e.g., selects the recommended URL remainder, accesses a favorite/bookmarked page, and/or otherwise interacts with the browser), the history protection extension of the first user device 503 may communicate with the cloud computing platform 502 to record any user interaction information as history data within the history sync service. In doing so, the history sync service may be continuously and dynamically updated based on any additional interaction information so as to improve the recommendation/suggestion capabilities of the history protection extension.

At step 613, the first user device 503 may display content corresponding to an accessed URL, and may continue to record any additional interaction information to the history sync service. In these instances, the first user device 503 may continually monitor whether or not the first user device 503 is operating on the secure internal network. If the first user device 503 detects that the first user device 503 is no longer on the secure internal network, it may no longer display the sensitive information, and may instead display only content of the URL, as is described below with regard to the second user device 504.

At step 614, the history protection extension of the second user device 504 may intercept a URL request from the user of the second user device 504. For example, actions performed by the second user device 504 at step 614 may be similar to those performed by the first user device 503 at step 607.

At step 615, the history protection extension of the second user device 504 may access the URL and cause it to be displayed at the second user device 504. However, rather than displaying the suggestions/recommendations, as described above with regard to the first user device 503 at step 611, the history protection extension of the second user device 504 may cause the second user device 504 to display a graphical user interface similar to graphical user interface 815, which is illustrated in FIG. 8B. For example, as shown in FIG. 8B, no sensitive information may be displayed (e.g., because the history protection extension of the second user device 504 previously identified at step 605 that the second user device 504 is not operating on the internal secure network). If the second user device 504 detects that the second user device 504 is now operating on the secure internal network, it may display the sensitive information along with content of the URL, as described above with regard to the first user device 503.

Although the above described actions, performed by the first user device 503 and the second user device 504 are illustrated as being performed sequentially, such actions may be performed by the first user device 503 and the second user device 504 simultaneously without departing from the scope of the disclosure.

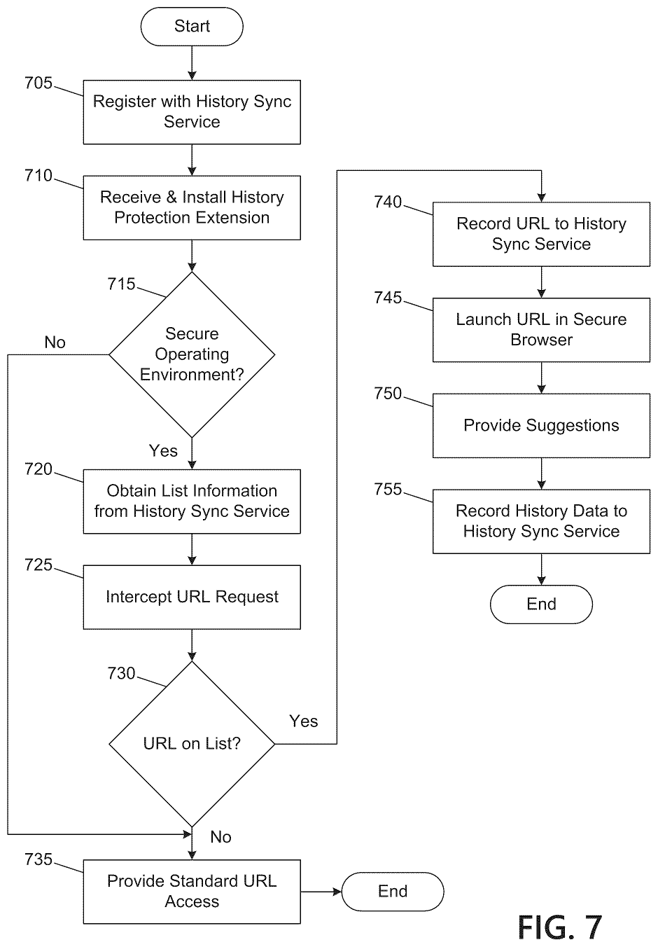

FIG. 7 depicts an illustrative method for secure storage and selective exposure of sensitive information in accordance with one or more example embodiments. Referring to FIG. 7, at step 705, a computing system comprising a memory and one or more processors may register with a cloud based history sync service. At step 710, the computing system may receive and install a history protection extension 710. At step 715, the computing system may identify whether or not it is operating on a secure internal network. If the computing system is not operating on a secure internal network, the computing system may proceed to step 735. At step 735, the computing system may provide access to the URL in a standard browser without providing any additional sensitive information.

Returning to step 715, if the computing system is operating on the secure internal network, the computing system may proceed to step 720. At step 720, the computing system may use the history protection extension to obtain history data and protection domain lists from the cloud based history sync service. At step 725, the computing system may use the history protection extension to intercept a URL access request. At step 730, the computing system may identify if the URL is on the protection domain list. If the URL is not on the protection domain list, the computing system may proceed to step 735. At step 735, the computing system may provide access to the URL in a standard browser without providing any additional sensitive information.

Returning to step 730, if the URL is on the protection domain list, the computing system may proceed to step 740. At step 740, the computing system may use the history protection extension to record the URL to the history sync service. At step 745, the computing system may launch the URL in a secure browser. At step 750, the computing system may provide recommendations/suggestions. At step 755, the computing system may record history data to the history sync service.

The following paragraphs (M1) through (M11) describe examples of methods that may be implemented in accordance with the present disclosure.
(M1) A method comprising receiving, from a cloud computing platform, a history protection extension for a web browser; automatically installing, at a user device, the history protection extension and based on receipt of the history protection extension, wherein installing the history protection extension causes the user device to selectively display sensitive information based on whether or not the user device is connected to a secure network; identifying, using the history protection extension, that the user device is currently operating on the secure network; intercepting, by the history protection extension, a uniform resource locator (URL) access request; comparing a domain of the URL access request to a protection domain list; and based on identifying that the domain of the URL is included on the protection domain list: launching the URL in a secure browser, wherein launching the URL in the secure browser causes browsing data to be recorded to the history sync service rather than a local browser; and displaying, within the secure browser and based on a history data list from a history synchronization service hosted by the cloud computing platform, the sensitive information.
(M2) A method may be performed as described in paragraph (M1) further comprising registering, by the user device and with the history synchronization service hosted at the cloud computing platform, the user device.
(M3) A method may be performed as described in paragraph (M2), wherein the installation of the history protection extension is automatically triggered based on the registration by the user device with the history synchronization service.
(M4) A method may be performed as described in any of paragraphs (M1) through (M3) further comprising, based on identifying that the user device is currently operating on the secure network, recording the URL to the history data list of the history synchronization service.
(M5) A method may be performed as described in any of paragraphs (M1) through (M4) further comprising based on identifying that the user device is currently operating on the secure network, recording user interaction information, corresponding to the sensitive information, to the history data list of the history synchronization service.
(M6) A method may be performed as described in paragraph (M5) wherein the history synchronization service is configured to update the sensitive information based on the user interaction information.
(M7) A method may be performed as described in any of paragraphs (M1) through (M6) further comprising: identifying that the user device is no longer operating on the secure network; and based on identifying that the user device is no longer operating on the secure network, identifying that the sensitive information should not be displayed.
(M8) A method may be performed as described in any of paragraphs (M1) through (M7) wherein identifying that the user device is operating on the secure network comprises: requesting access to an internal URL; and based on identifying that access is granted to the internal URL, identifying that the user device is operating on the secure network.
(M9) A method may be performed as described in any of paragraphs (M1) through (M8) wherein the sensitive information includes one or more of: URL autocomplete information, recommendation information, URL favorites information, or information of the URL.
(M10) A method may be performed as described in any of paragraphs (M1) through (M9) wherein the sensitive information includes bookmark information.
(M11) A method may be performed as described in any of paragraphs (M1) through (M10) further comprising: based on identifying that the domain of the URL is not included on the protection domain list, launching the URL in a standard browser.

The following paragraphs (A1) through (A8) describe examples of apparatuses that may be implemented in accordance with the present disclosure.
(A1) A computing system comprising a processor; memory storing computer executable instructions that, when executed by the processor, cause the computing system to: receive, from a cloud computing platform, a history protection extension for a web browser; automatically install, at the computing system and based on receipt of the history protection extension, the history protection extension, wherein installing the history protection extension causes the computing system to selectively display sensitive information based on whether or not the computing system is connected to a secure network; identify, using the history protection extension, that the computing system is currently operating on the secure network; intercept, by the history protection extension, a uniform resource locator (URL) access request; compare a domain of the URL access request to a protection domain list; and based on identifying that the domain of the URL is included on the protection domain list: launch the URL in a secure browser, wherein launching the URL in the secure browser causes browsing data to be recorded to the history sync service rather than a local browser; and display, within the secure browser and based on a history data list from a history synchronization service hosted by the cloud computing platform, the sensitive information.
(A2) A computing system as described in paragraph (A1), wherein the memory stores additional computer readable instructions that, when executed by the one or more processors, cause the computing system to: register, by the computing system and with the history synchronization service hosted at the cloud computing platform, the computing system.
(A3) A computing system as described in paragraph (A2), wherein the installation of the history protection extension is automatically triggered based on the registration by the computing system with the history synchronization service.
(A4) A computing system as described in any of paragraphs (A1) through (A3) wherein the memory stores additional computer readable instructions that, when executed by the one or more processors, cause the computing system to: based on identifying that the computing system is currently operating on the secure network, record the URL to the history data list of the history synchronization service.
(A5) A computing system as described in any of paragraphs (A1) through (A4) wherein the memory stores additional computer readable instructions that, when executed by the one or more processors, cause the computing system to: based on identifying that the computing system is currently operating on the secure network, record user interaction information, corresponding to the sensitive information, to the history data list of the history synchronization service.
(A6) A computing system as described in paragraph (A5) wherein the history synchronization service is configured to update the sensitive information based on the user interaction information.
(A7) A computing system as described in any one of paragraphs (A1) through (A6) wherein the memory stores additional computer readable instructions that, when executed by the one or more processors, cause the computing system to: identify that the computing system is no longer operating on the secure network; and based on identifying that the computing system is no longer operating on the secure network, identify that the sensitive information should not be displayed.
(A8) A computing system as described in any one of paragraphs (A1) through (A7) wherein identifying that the computing system is operating on the secure network comprises: requesting access to an internal URL; and based on identifying that access is granted to the internal URL, identifying that the computing system is operating on the secure network.

The following paragraph (CRM1) describes examples of computer-readable media that may be implemented in accordance with the present disclosure.
(CRM1) A non-transitory computer-readable medium storing instructions that, when executed, cause a system to perform receive, from a cloud computing platform, a history protection extension for a web browser; automatically install, at the computing system and based on receipt of the history protection extension, the history protection extension, wherein installing the history protection extension causes the computing system to selectively display sensitive information based on whether or not the computing system is connected to a secure network; identify, using the history protection extension, that the computing system is currently operating on the secure network; intercept, by the history protection extension, a uniform resource locator (URL) access request; compare a domain of the URL access request to a protection domain list; and based on identifying that the domain of the URL is included on the protection domain list: launch the URL in a secure browser, wherein launching the URL in the secure browser causes browsing data to be recorded to the history sync service rather than a local browser; and display, within the secure browser and based on a history data list from a history synchronization service hosted by the cloud computing platform, the sensitive information.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, from a cloud computing platform, a history protection extension for a web browser;
automatically installing, at a user device and based on receipt of the history protection extension, the history protection extension, wherein installing the history protection extension causes the user device to selectively display sensitive information based on whether or not the user device is connected to a secure network;
identifying, using the history protection extension, that the user device is currently operating on the secure network;
intercepting, by the history protection extension, a uniform resource locator (URL) access request;
comparing a domain of the URL access request to a protection domain list; and
based on identifying that the domain of the URL is included on the protection domain list:
launching the URL in a secure browser, wherein launching the URL in the secure browser causes browsing data to be recorded to the history sync service rather than a local browser; and
displaying, within the secure browser and based on a history data list from a history synchronization service hosted by the cloud computing platform, the sensitive information.

2. The method of claim 1, further comprising:
registering, by the user device and with the history synchronization service hosted at the cloud computing platform, the user device.

3. The method of claim 2, wherein the installation of the history protection extension is automatically triggered based on the registration by the user device with the history synchronization service.

4. The method of claim 1, further comprising:
based on identifying that the user device is currently operating on the secure network, recording the URL to the history data list of the history synchronization service.

5. The method of claim 1, further comprising:
based on identifying that the user device is currently operating on the secure network, recording user interaction information, corresponding to the sensitive information, to the history data list of the history synchronization service.

6. The method of claim 5, wherein the history synchronization service is configured to update the sensitive information based on the user interaction information.

7. The method of claim 1, further comprising:
identifying that the user device is no longer operating on the secure network; and
based on identifying that the user device is no longer operating on the secure network, identifying that the sensitive information should not be displayed.

8. The method of claim 1, wherein identifying that the user device is operating on the secure network comprises:
requesting access to an internal URL; and
based on identifying that access is granted to the internal URL, identifying that the user device is operating on the secure network.

9. The method of claim 1, wherein the sensitive information includes one or more of: URL autocomplete information, recommendation information, URL favorites information, or information of the URL.

10. The method of claim 1, wherein the sensitive information includes bookmark information.

11. The method of claim 1, further comprising:
based on identifying that the domain of the URL is not included on the protection domain list, launching the URL in a standard browser.

12. A computing system comprising:
a processor;
memory storing computer executable instructions that, when executed by the processor, cause the computing system to:
receive, from a cloud computing platform, a history protection extension for a web browser;
automatically install, at the computing system and based on receipt of the history protection extension, the history protection extension, wherein installing the history protection extension causes the computing system to selectively display sensitive information based on whether or not the computing system is connected to a secure network;
identify, using the history protection extension, that the computing system is currently operating on the secure network;
intercept, by the history protection extension, a uniform resource locator (URL) access request;
compare a domain of the URL access request to a protection domain list; and
based on identifying that the domain of the URL is included on the protection domain list:
launch the URL in a secure browser, wherein launching the URL in the secure browser causes browsing data to be recorded to the history sync service rather than a local browser; and
display, within the secure browser and based on a history data list from a history synchronization service hosted by the cloud computing platform, the sensitive information.

13. The computing system of claim 12, wherein the memory stores additional computer readable instructions that, when executed by the one or more processors, cause the computing system to:
register, by the computing system and with the history synchronization service hosted at the cloud computing platform, the computing system.

14. The computing system of claim 13, wherein the installation of the history protection extension is automatically triggered based on the registration by the computing system with the history synchronization service.

15. The computing system of claim 12, wherein the memory stores additional computer readable instructions that, when executed by the one or more processors, cause the computing system to:
based on identifying that the computing system is currently operating on the secure network, record the URL to the history data list of the history synchronization service.

16. The computing system of claim 12, wherein the memory stores additional computer readable instructions that, when executed by the one or more processors, cause the computing system to:
based on identifying that the computing system is currently operating on the secure network, record user interaction information, corresponding to the sensitive information, to the history data list of the history synchronization service.

17. The computing system of claim 16, wherein the history synchronization service is configured to update the sensitive information based on the user interaction information.

18. The computing system of claim 12, wherein the memory stores additional computer readable instructions that, when executed by the one or more processors, cause the computing system to:
identify that the computing system is no longer operating on the secure network; and
based on identifying that the computing system is no longer operating on the secure network, identify that the sensitive information should not be displayed.

19. The computing system of claim 12, wherein identifying that the computing system is operating on the secure network comprises:
requesting access to an internal URL; and
based on identifying that access is granted to the internal URL, identifying that the computing system is operating on the secure network.

20. One or more non-transitory computer-readable media storing instructions that, when executed by a computing system comprising at least one processor, a communication interface, and memory, cause the computing system to:
receive, from a cloud computing platform, a history protection extension for a web browser;
automatically install, at the computing system and based on receipt of the history protection extension, the history protection extension, wherein installing the history protection extension causes the computing system to selectively display sensitive information based on whether or not the computing system is connected to a secure network;
identify, using the history protection extension, that the computing system is currently operating on the secure network;
intercept, by the history protection extension, a uniform resource locator (URL) access request;
compare a domain of the URL access request to a protection domain list; and
based on identifying that the domain of the URL is included on the protection domain list:
launch the URL in a secure browser, wherein launching the URL in the secure browser causes browsing data to be recorded to the history sync service rather than a local browser; and
display, within the secure browser and based on a history data list from a history synchronization service hosted by the cloud computing platform, the sensitive information.
